(19) United States
(12) Patent Application Publication
(10) Pub. No.: US 2021/0378078 A1
(43) Pub. Date: Dec. 2, 2021

(54) PROTECTION STRUCTURE FOR ELECTROSTATIC DISCHARGE

(71) Applicants: Chih-Chiang Pai, Taoyuan (TW); Meng-Kuei Lin, Taoyuan (TW); Chin-Fong Lin, Taoyuan (TW); Li-Yeh Yang, Taoyuan (TW); Chiu-Hsia Li, Taoyuan (TW)

(72) Inventors: Chih-Chiang Pai, Taoyuan (TW); Meng-Kuei Lin, Taoyuan (TW); Chin-Fong Lin, Taoyuan (TW); Li-Yeh Yang, Taoyuan (TW); Chiu-Hsia Li, Taoyuan (TW)

(73) Assignee: Young Fast Optoelectronics Co., Ltd., Taoyuan (TW)

(21) Appl. No.: 16/889,801

(22) Filed: Jun. 2, 2020

(51) Int. Cl. H05F 3/00

(52) U.S. Cl. CPC H05F 3/00; G06F 3/041

(57) ABSTRACT

A protection structure includes a substrate, a signal wire pattern, a protective ring and micro-blocks. The substrate has a touch sensing pattern including sensing strings. The signal wire pattern has conductive wires. Each conductive wire electrically connects one of the sensing strings to a signal processor. The protective ring is formed at a peripheral zone of the substrate and around the touch sensing pattern. The micro-blocks are disposed in the protective ring and have electric conductivity. A gap is disposed between every adjacent two of the micro-blocks for insulation.

### TECHNICAL FIELD

The invention relates to touch sensors, particularly to a protector for preventing a touch sensor from impact of static electricity.

### RELATED ART

With development and popularization of electronic devices, more and more touch sensors are applied in daily life of people. Basically, a common touch sensor is to dispose a touch sensing pattern and signal wires on a substrate. The touch sensing pattern includes X-axis sensing strings and Y-axis sensing strings. The X-axis sensing strings and the Y-axis sensing strings are orthogonally arranged. The signal wires separately connect the X-axis sensing strings and the Y-axis sensing strings to a signal processor. A user touches a surface of the touch sensor with his/her finger to make static electric charges on the finger delivered to the touch sensor for touch operation. However, usually, ICs of the touch sensor can only withstand tens of volts. To prevent damage, it is required that electrostatic discharge (ESD) enters a touch sensor. Thus, a great touch sensor must solve not only a problem of touch signal sensitivity but also a problem of reliability of the sensor, especially for protection to ESD.

The ESD phenomenon means an electronic device will be affected when it is touched by an object which can transfer charges. This may make an electronic device unstable or damaged. For example, ESD phenomenon may occur when a human body is touching a connector of an electronic device.

To protect an internal circuit to prevent from the ESD phenomenon, an ESD protector may be disposed. Usually, an ESD protector of a touch sensor is to attach an insulative material or a conductive material to resist or guide ESD. The most common ESD protector of touch sensor is to short most currents to the ground or to make most ESD currents clamped to a predetermined value by a voltage between two electrodes of a TVS diode. A protective effect can be obtained by guiding electrostatic charges to a system ground. However, when the grounding is unfirm or improper to cause an overhigh impedance, ESD will bring serious damage.

### SUMMARY OF THE INVENTION

An object of the invention is to provide a protection structure for electrostatic discharge, which can effectively resist or reduce ESD breakdown currents to enter an internal circuit. This can prevent internal chips from being damaged.

To accomplish the above object, the protection structure for electrostatic discharge of the invention includes a substrate, a signal wire pattern, a protective ring and micro-blocks. The substrate has a touch sensing pattern including sensing strings. The signal wire pattern has conductive wires. Each conductive wire electrically connects one of the sensing strings to a signal processor. The protective ring is formed at a peripheral zone of the substrate and around the touch sensing pattern. The micro-blocks are disposed in the protective ring and have electric conductivity. A gap is disposed between every adjacent two of the micro-blocks for insulation.

Preferably, the protective ring is greater than 5.5 mm in width.

Preferably, each of the micro-blocks is hexagonal, triangular, rectangular, trapezoidal or circular in shape.

Preferably, the micro-blocks comprises two or more of hexagon, triangle, rectangle, trapezoid or circle in shape.

Preferably, the gap is above 25 μm in width.

Another embodiment of the protection structure for electrostatic discharge includes a substrate, a signal wire pattern and a protective ring. The substrate has a touch sensing pattern including sensing strings. The signal wire pattern has conductive wires. Each conductive wire electrically connects one of the sensing strings to a signal processor. The protective ring is formed at a peripheral zone of the substrate and around the touch sensing pattern. The protective ring is an insulative sheet.

Preferably, the protective ring is greater than 5.5 mm in width.

Preferably, the insulative sheet is made of polycarbonate (PC), polyester (PET), polymethyl methacrylate (PMMA) or cycloolefin copolymer (COC).

### BRIEF DESCRIPTION OF THE DRAWINGS

FIG. 1 is a schematic plan view of the touch sensor of the first embodiment of the invention;

FIG. 2 is an enlarged view of portion A in FIG. 1, which depicts the distribution of the micro-blocks in the protective ring;

FIG. 3 is a sectional view along line III-III in FIG. 1;

FIG. 4 is an enlarged view of portion A in FIG. 1, which depicts another distribution of the micro-blocks in the protective ring;

FIG. 5 is an enlarged view of portion A in FIG. 1, which depicts still another distribution of the micro-blocks in the protective ring;

FIG. 6 is a schematic plan view of the touch sensor of the second embodiment of the invention; and

FIG. 7 is a sectional view along line VII-VII in FIG. 6.

### DETAILED DESCRIPTION OF THE INVENTION

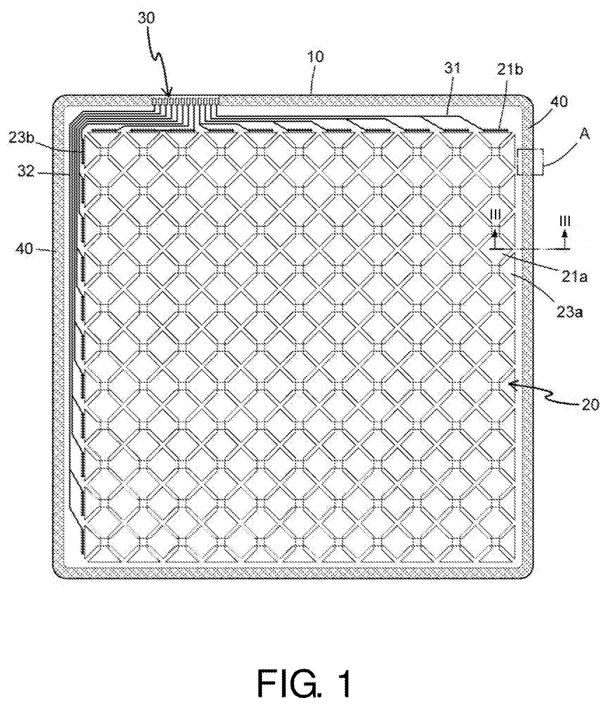

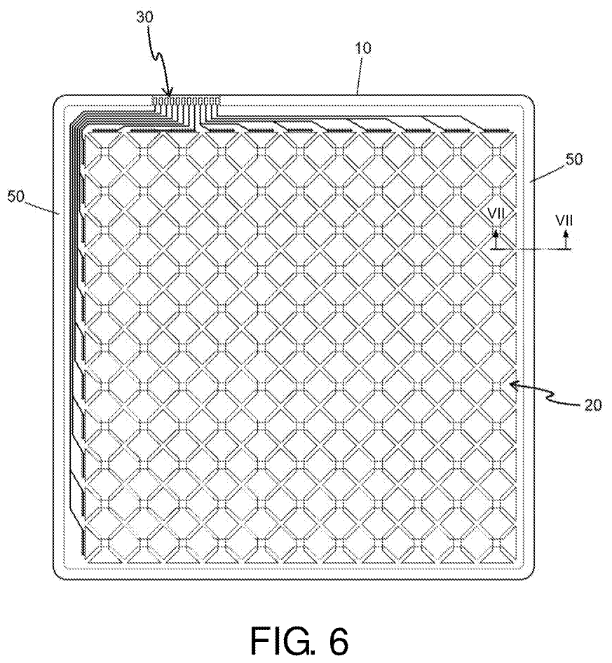

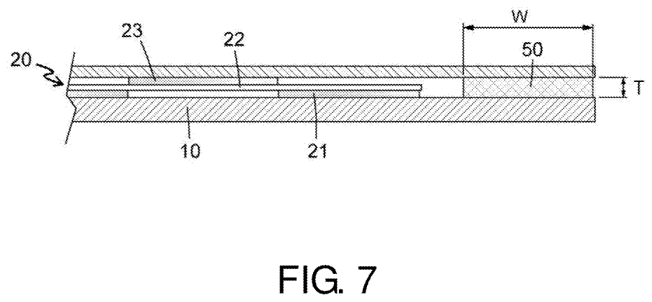

FIGS. 1-5 depict the touch sensor of the first embodiment of the invention. FIGS. 6-7 depict the touch sensor of the second embodiment of the invention. Preferred embodiments are depicted in the drawings. To make the invention more understandable, some elements in the drawings are not drawn in an accurate scale and sizes of some elements are enlarged with respect to other elements. For the sake of clearness, irrelative details are not drawn.

As shown in FIGS. 1-3, the protection structure for electrostatic discharge of the first embodiment of the invention includes a substrate 10, a touch sensing pattern 20, a signal wire pattern 30 and a protective ring 40.

The substrate 10 is a board with dielectricity and high transmittance, which is made of, but not limited to, polycarbonate (PC), polyester (PET), polymethyl methacrylate (PMMA) or cycloolefin copolymer (COC). Other flexible or rigid transparent materials are available.

The touch sensing pattern 20 is disposed on a surface of the substrate 10. In this embodiment, the touch sensing pattern 20 is consisted of a first sensing layer 21, an insulative layer 22 and a second sensing layer 23, which are superposed in order. The first sensing layer 21 (i.e., Y-axis sensing layer) is an ITO conductive film with high transmittance and includes Y-axis sensing strings 21a along Y-axis. Each Y-axis sensing string 21a is formed by rhombic capacitive sensing units connected in series. A capacitive signal contact 21b is provided at the top of each Y-axis sensing string 21a. The second sensing layer 23 (i.e., X-axis sensing layer) is an ITO conductive film with high transmittance and includes X-axis sensing strings 23a along X-axis. Each X-axis sensing string 23a is formed by rhombic capacitive sensing units connected in series. A capacitive signal contact 23b is provided at the left of each X-axis sensing string 23a. The insulative layer 22 is sandwiched between the first and second sensing layers 21, 23 for insulation and separation. The insulative layer 22 may be made of solid optically clear adhesive (OCA) or liquid optically clear resin (OCR) for adhesion. As shown in FIG. 1, when the two sensing layers 21, 23 have been assembled, the Y-axis sensing strings 21a and the X-axis sensing strings 23a are orthogonal and the capacitive sensing units of the X-axis sensing strings 23a and Y-axis sensing strings 21a cross in a complementary manner to form a rhombic capacitive sensing unit array.

The signal wire pattern 30 includes Y-axis wires 31 and X-axis wires 32. The Y-axis wires 31 separately electrically connect the capacitive signal contacts 21b of the Y-axis sensing strings 21a to a signal processor (not shown) and the X-axis wires 32 separately electrically connect the capacitive signal contacts 23b of the X-axis sensing strings 23a to the signal processor.

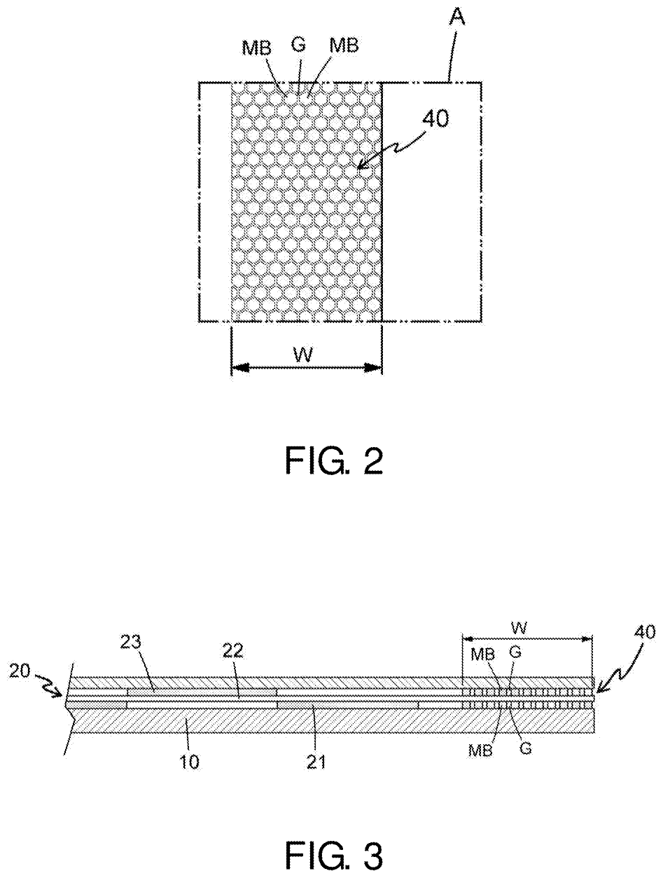

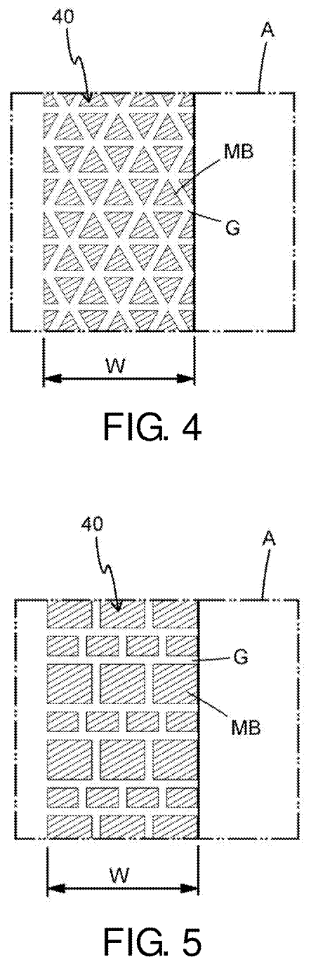

The protective ring 40 is disposed at a peripheral zone of the substrate 10 and around the touch sensing pattern 20. A width W of the protective ring 40 is above 5.5 mm, preferably between 7.5 mm and 10 mm. Multiple micro-blocks MB are evenly distributed in the protective ring 40. In this embodiment, a width W of the protective ring 40 is 8 mm and the micro-blocks MB in the protective ring 40 is formed by the first and second sensing layers 21, 23 treated with Laser cutting. The micro-blocks MB are cut to be separate from each other. A gap G is disposed between every adjacent two of the micro-blocks MB for insulation and separation. Preferably, the gap G is about greater than 25 μm, more preferably, between 30 μm and 50 μm for better insulation. Usually, the gap G is configured to be 30 μm and the gap G must completely cut off the ITO conductive material of the first and second sensing layers 21, 23. The micro-blocks MB may be shaped to be hexagonal as shown in FIG. 2, triangular as shown in FIG. 4, rectangular as shown in FIG. 5, trapezoidal, longitudinal, polygonal, circular or combinations of two or more of these shapes. By the protective ring 40, an ESD breakdown current can be resisted or reduced to enter the inside of the touch sensor. According to experiments in compliance with the ESD IEC 61000-4-2 test specification, the protective ring 40 of the invention can pass the level 4 contact discharge and air discharge. Thus the touch sensor of the invention has great protection to ESD.

Please refer to FIGS. 6-7. The second embodiment of the invention includes a substrate 10, a touch sensing pattern 20, a signal wire pattern 30 and a protective ring 50. The second embodiment differs the first embodiment by the protective ring 50. The protective ring 50 is an insulative sheet. A width of the protective ring 50 is above 5.5 mm, preferably between 7.5 mm and 10 mm. The protective ring 50 is made of, but not limited to, polycarbonate (PC), polyester (PET), polymethyl methacrylate (PMMA) or cycloolefin copolymer (COC). In this embodiment, the protective ring 50 has a width of about 8 mm and a thickness T which is substantially the same as that of the touch sensing pattern 20 for matching. According to experiments in compliance with the ESD IEC 61000-4-2 test specification, the protective ring 40 of the invention can pass the level 4 air discharge+point test finger. Thus the touch sensor of the invention has great protection to ESD.

It will be appreciated by persons skilled in the art that the above embodiments have been described by way of example only and not in any limitative sense, and that various alterations and modifications are possible without departure from the scope of the invention as defined by the appended claims.

What is claimed is:

1. A protection structure for electrostatic discharge, comprising:
a substrate, having a touch sensing pattern, and the touch sensing pattern having sensing strings;
a signal wire pattern, having conductive wires, and each conductive wire electrically connecting one of the sensing strings;
a protective ring, formed at a peripheral zone of the substrate and around the touch sensing pattern, and
micro-blocks, disposed in the protective ring, having electric conductivity, wherein a gap is disposed between every adjacent two of the micro-blocks for insulation.

2. The protection structure of claim 1, wherein the protective ring is greater than 5.5 mm in width.

3. The protection structure of claim 1, wherein each of the micro-blocks is hexagonal, triangular, rectangular, trapezoidal or circular in shape.

4. The protection structure of claim 3, wherein the micro-blocks comprises two or more of hexagon, triangle, rectangle, trapezoid or circle in shape.

5. The protection structure of claim 1, wherein the gap is above 25 μm in width.

6. A protection structure for electrostatic discharge, comprising:
a substrate, having a touch sensing pattern, and the touch sensing pattern having sensing strings;
a signal wire pattern, having conductive wires, and each conductive wire electrically connecting one of the sensing strings;
a protective ring, formed at a peripheral zone of the substrate and around the touch sensing pattern, and being an insulative sheet.

7. The protection structure of claim 6, wherein the protective ring is greater than 5.5 mm in width.

8. The protection structure of claim 6, wherein the insulative sheet is made of polycarbonate (PC), polyester (PET), polymethyl methacrylate (PMMA) or cycloolefin copolymer (COC).
